(19) United States
(12) Patent Application Publication
(10) Pub. No.: US 2004/0111939 A1
(43) Pub. Date: Jun. 17, 2004

(54) Magnacardholder

(76) Inventor: G.C. Harned, Carrollton, TX (US)

Correspondence Address: CHOICES OR CHANCES INC, PMB 114-173, 4009 Old Denton Rd., Carrollton, TX, 75007, US

(21) Appl. No.: 10/158,302

(22) Filed: Dec. 13, 2002

(51) Int. Cl. G09F 7/04

(52) U.S. Cl. 40/600

(57) ABSTRACT

The Magnacardholder is a clear plastic display type item. Magnetic backing to bond to any metal object; car, truck, vending etc. Artwork slides in slot on back and a box to place business cards is on the front.

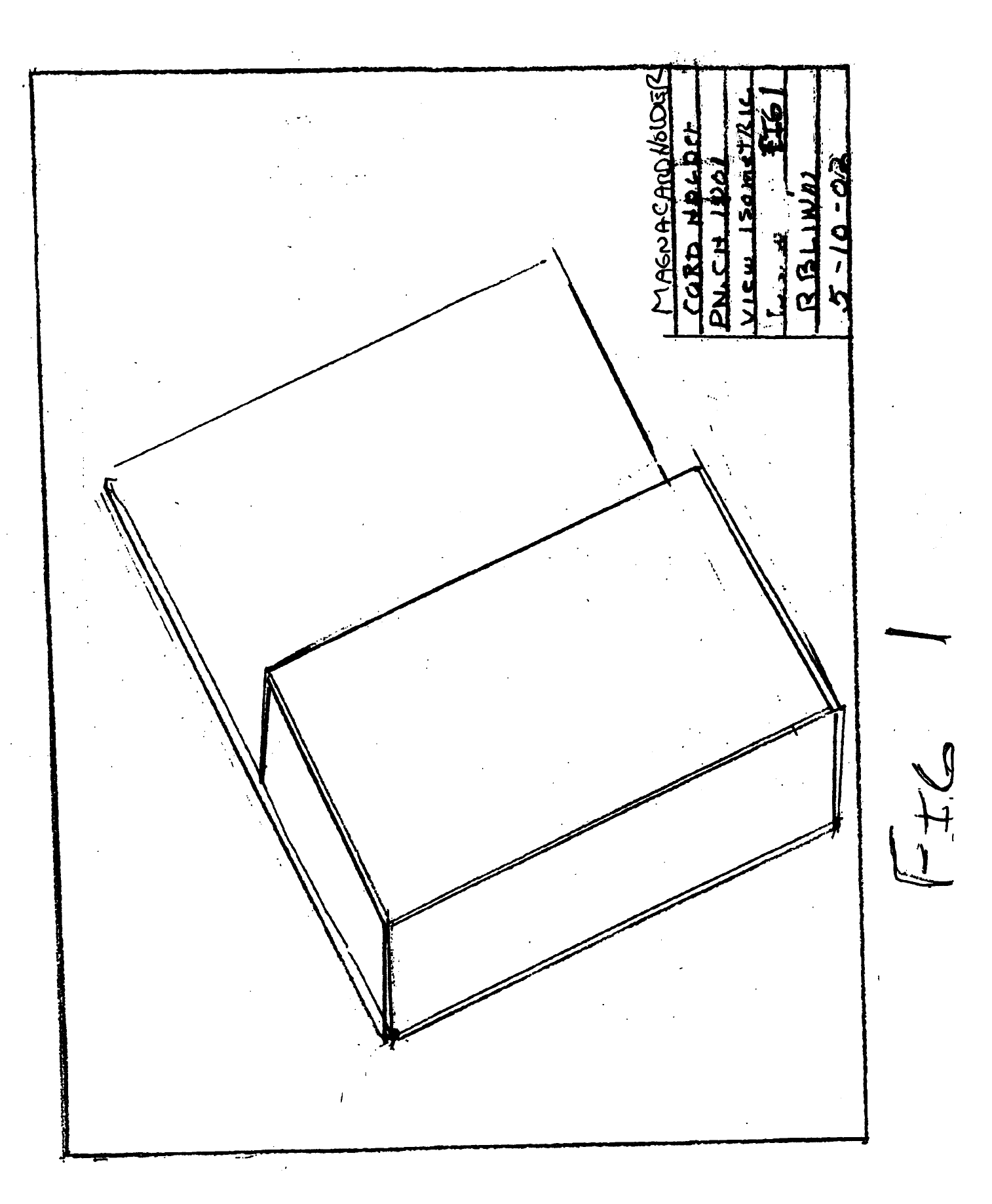

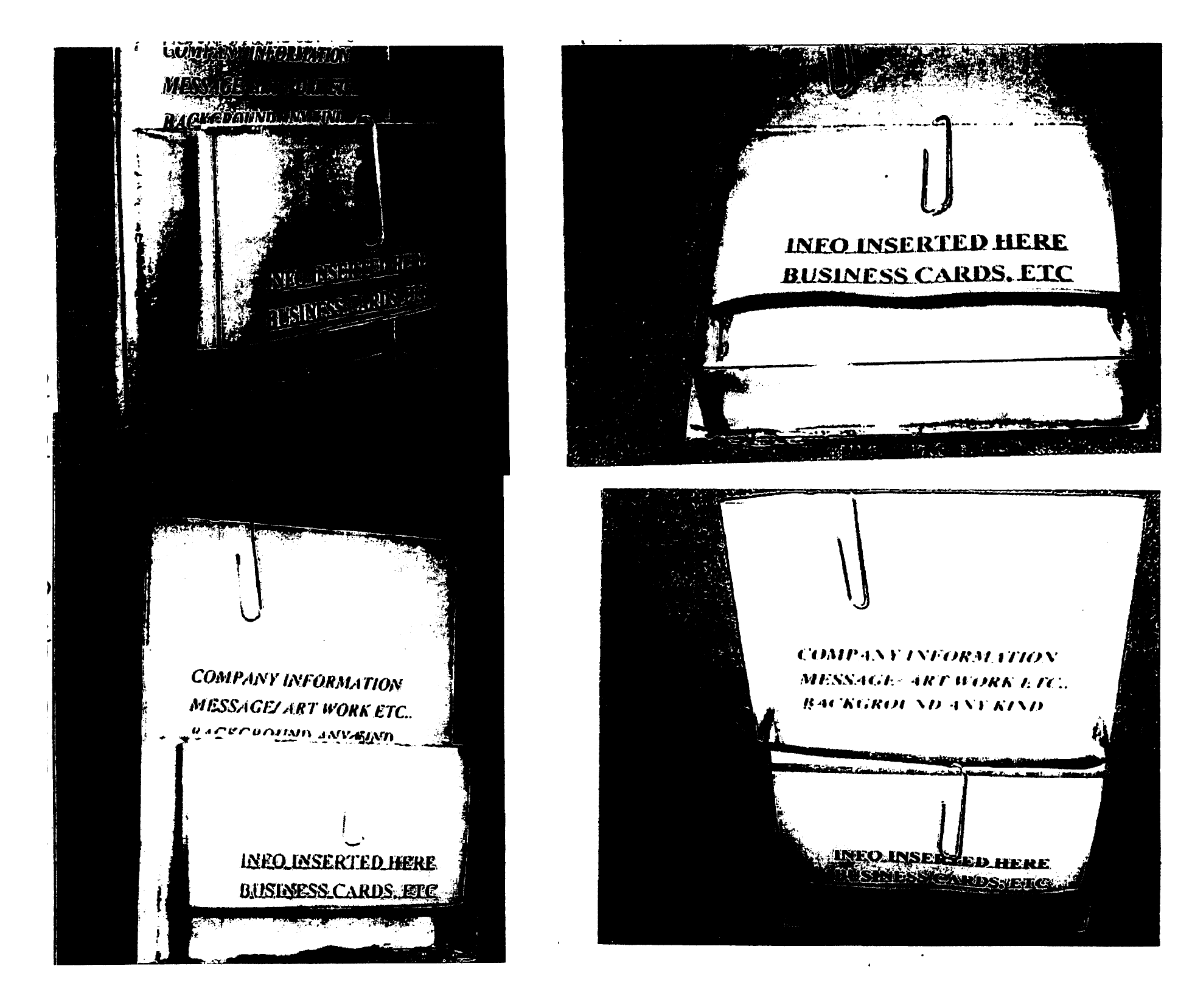

Magnetic backing differentiates item from any other similar item.

### SUMMARY OF MAGNACARDHOLDER

The Magnacardholder will allow parked Contractors, Realtors, Artists to display business cards without permanent attachment to the vehicle or metal surface like a soda machine or phone booth. At this point there is no product that allows ease of removal, no damage to the surface, moveable from location to location, product display specific to numerous fields. Being a contractor the need for this type item is unlimited for advertising such as in a parking lot when out of my vehicle and not able to distribute information.

### OVERVIEW DESCRIPTION MAGNACARDHOLDER

A hard plastic holder designed to hold information on the outside of cars, trucks, or any metal object. A display device to be used for Realtor, Contractors, Fairs Vendors, Etc. . . .

The device is 4″×5″×1″ and will be backed with a magnetic sheet. Cards fit into an open slot on front and art work is installed onto the back facing forward. Then the item is attached by magnet to the exterior of above stated items.

This allows for easy marketing without having to permanently attach the item to anything.

Easily moving from vehicle to vehicle as desired as well as remove during bad weather.

The Magnacardholder is an inexpensive mass media marketing tool to help grow businesses or product awareness.

### DESCRIPTION OF DRAWING

Simple drawing showing blow up of Magnacardholder. Slot on back for artwork for applicable user. Slot in front for business cards and backing of magnet for attachment. Photos show more detail.

1. The magnacardholder is a product that will hold business cards or literature specifically to metal objects. Cars, trucks, vending machines, file cabs, etc. The holder is used to spread advertising, specification, flyers. Place on any of the above objects and with no damage to the object spread the word.
